(19) United States
(12) Patent Application Publication
(10) Pub. No.: US 2026/0227125 A1
(43) Pub. Date: Aug. 6, 2026

(54) MATERIAL DRYING PROCESSES

(71) Applicant: B&T Technologies, LLC, Coral Springs, FL (US)

(72) Inventor: William H. Moss, Coral Springs, FL (US)

(21) Appl. No.: 19/043,811

(22) Filed: Feb. 3, 2025

(51) Int. Cl. F26B 3/08; F26B 21/20

(52) U.S. Cl. CPC F26B 3/08; F26B 21/20; F26B 2200/02

(57) ABSTRACT

A material drying process is disclosed, including the steps of grinding a wet heterogeneous raw material to transform into a homogenous mixture. The wet homogeneous raw material is mixed with an amount of recycled fines and an amount of recycled dry material to texturize into a mixture that will hold its shape when extruded into a uniform size and shape. The mixture is pelletized into uniform cylindrical spaghetti-like strands and is then dried. The mixture is then heated in a conditioner for a predetermined time period and is then cooled in a cooler. The mixture is then processed and packaged as a final product.

### CROSS-REFERENCE TO RELATED APPLICATIONS

The present application claims priority to U.S. Provisional Patent Application No. 63/556,739 filed February 2, 2024, titled “MATERIAL DRYING PROCESS FOR DRYING AND DEHYDRATING WET FEEDSTOCK”; U.S. Provisional Application No. 63/558,422 filed February 27, 2024, titled “MATERIAL DRYING PROCESS DESIGNED TO MANAGE MULTIPLE FEEDSTOCKS”; U.S. Provisional Application No. 63/558,491 filed February 27,2024, titled “MATERIAL DRYING PROCESS USING RECYCLED EXHAUST GAS FINES”; U.S. Provisional Application No. 63/562,092 filed March 6, 2024, titled “MATERIAL DRYING PROCESS HAVING A CONDITIONER TO REDUCE PATHOGENS,”; U.S Provisional Patent Application No. 63/562,097 filed March 6, 2024, titled “MATERIAL DRYING PROCESS HAVING PRODUCT SAFETY AND STORAGE IMPROVEMENTS”, each of which is hereby incorporated by reference in its entirety.

### TECHNICAL FIELD

The present invention relates generally to material drying processes.

### BACKGROUND

Many techniques and procedures utilized in processing of diverse materials to obtain a particular end product also result in formation of a residue or by-product containing a high proportion of moisture. Such residue or by-products collectively termed "residual products" must be disposed of by methods or techniques that satisfy ecological standards and safety requirements. However, these residual products, because of their high moisture content, present disposal problems. Some residual products contain significant nutrient value so that they could be utilized as livestock, animal or poultry feed, or as agricultural fertilizer, but a high moisture content makes them difficult and costly to handle and utilize for those purposes and they are often simply disposed of as useless waste. For the same reason, a number of residual products that have potential as a source of energy can only be consigned to ultimate disposal such as in landfills. Generally, these residual products have a moisture content that is so proportionally high with respects to their solids, that they are not susceptible to economically feasible further processing to a state that permits their utilization.

One type of drying apparatus that has been utilized to effect drying of high moisture content materials is the, spray dryer. With this apparatus, the material to be dried is sprayed into a confined space through which heated air is caused to flow and effect vaporization of moisture from the material, leaving dry solids with the vaporized moisture being exhausted to the atmosphere. While a spray dryer can effect drying of some high moisture content materials, it accomplishes this drying with input of a relatively large amount of energy in the form of heat, and also mechanical, to cause a flow of large quantities of air at high velocity. Consequently, spray drying is a costly technique that cannot be economically justified for many residual products.

Another type of drying apparatus that has been utilized for drying of some high moisture content materials is the fluidized bed dryer. A fluidized bed dryer has a bedplate formed with apertures and on which the moist materials are placed. Heated air is caused to flow upwardly through the apertures and the material at volumes and velocities to effect fluidizing of the material with the objective of vaporization of the moisture. This technique does not work well with some materials as moist solids tend to agglomerate into large masses. The fluidizing heated air has difficulty in penetrating these agglomerated masses and, thus, the agglomerated material retains moisture in the interior of those masses and they are only dried on the outside. When these agglomerated masses of material are processed through the dryer, the retained moisture will move to their exterior, become sticky and tend to stick to subsequent processing apparatus as well as being an unacceptable, unusable product and which may cause the entire mass to spoil.

In particular, techniques previously used to effect drying of many organic materials have not found widespread use for economic reasons. The techniques for removal of the moisture have generally required input of substantial energy, primarily in the form of heat to effect vaporization of the moisture and enable it to be removed from the body of material. Organic materials, when processed by prior techniques, often exhibit a strong tendency to agglomerate into large masses that further hinders their drying.

Typical of the materials which are particularly adapted to the processing technique of this invention are the by-products that are produced from such processing operations in producing poultry products for human consumption and also in processing of milk products where a generally un-utilizable material such as whey may be produced. Also, residue materials from slaughterhouse operations are often incapable of being readily used for production of food products, such as for cats and dogs, as they contain excessive amounts of moisture. Materials of that nature are difficult and uneconomical to process as the residual moisture content requires employment of preservation techniques such as refrigeration, in many cases, to maintain the product in a palatable state for consumption by animals. This problem is further compounded by the fact that materials containing high levels of moisture are normally only susceptible to storage for relatively short periods of time unless they are refrigerated or processed into storage containers that are suitable for preserving the contents. The requirement for utilization of such containers further compounds the problems of processing such materials as the containers represent a significant economic factor. Transportation of high moisture content materials is also economically disadvantageous.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a material drying process, including the steps of grinding a wet heterogeneous raw material to transform into a homogenous mixture. The wet homogeneous raw material is mixed with an amount of recycled fines and an amount of recycled dry material to texturize into a mixture that will hold its shape when extruded into a uniform size and shape. The mixture is pelletized into uniform cylindrical spaghetti-like strands and is then dried. The mixture is then heated in a conditioner for a predetermined time period and is then cooled in a cooler. The mixture is then processed and packaged as a final product.

In some aspects, the mixture is dried by passing the uniform cylindrical spaghetti-like strands through fluidizing hot air that is heated above the boiling temperature of water.

In some aspects, the final product is dried below 10% moisture.

In some aspects, the final product is stable for 6-9 months.

In some aspects, the material drying process utilized a sufficient amount of recycled exhaust gas fines.

In some aspects, the system includes a conditioner that maintains the dried product in the presence of hot air that is held at the boiling temperature of water for a specific period of time to reduce pathogens in the final product.

In some aspects, the process is utilized to dry and dehydrate a single wet feedstock or a plurality of wet feedstocks.

In some aspects, the process is designed to manage a plurality of feedstocks comprised of a plurality of input products placed into a plurality of mixers in series.

In some aspects, a plurality of recycled gas fines are mixed with the plurality of input products and the recycled dry material of the same input products.

In some aspects, the method further comprises the following steps: collecting, via one or more high-efficiency cyclones, a plurality of exhaust gas fines; transporting the plurality of exhaust gas fines to an inlet hopper and a series of augers; transporting the plurality of exhaust fines to the plurality of mixers; pelletizing the mixture into a single wet material mixed texturized with fines and dried product of the same single ingredient, or pelletizing the mixture of two or more wet raw materials texturized with fines and dried product of the same mixture of two or more wet raw ingredients; and drying pelletized material derived from a single wet texturized material or two or more texturized wet raw materials.

The disclosed process removes the previous need for using a coagulator as an initial step. This new method allows for the product to be pelletized or otherwise processed into a dehydrated/dried product that is below 10% moisture which is considered dehydrated/dried and stable for 6-9 month shelf life, said product which can be used in various industries. The final product may be used as a livestock feed, fertilizer or fertilizer component, animal feed, poultry feed, etc.

The embodiments make it possible to have multiple wet and dry raw materials to combine to make any recipe, and therefore multiple final products using the plurality of mixers in series. The operator can select to blend a recipe with multiple ingredients while preserving wet feed stocks in multiple surge tanks.

The prior art does not include a conditioner which provides a heat soaking chamber that holds the pellets at a desired temperature for a period of time. The embodiments provided herein include a conditioner which allows the system to comply with USDA regulations for heat treating the products to reduce pathogens.

The prior art does not include the step of cooling once it is removed from the fluid bed dryer. Rather, the prior art only provides a cooling step for the dried product which is ground and returned to the mixer to texturize the feedstock prior to the pelletizing and drying steps. The step of cooling the finished material after the fluid bed dryer is beneficial for preventing the fire hazard which is common when storing a dried organic product above 145° Fahrenheit (or 63° Celsius).

In the disclosed process, wet and dry materials are ground to texturize the multiple wet and dry raw materials. A plurality of mixers in series are used to mix the multiple wet and dry materials to accommodate various recipes to produce various final products. Exhaust gas fines are collected by a high-efficiency cyclone. The exhaust gas fines are transported first to an inlet hopper, then to a series of augers. The exhaust gas fines are then fed to the plurality of mixers, thus recycling the exhaust gas fines to prevent waste, increase efficiency, and reduce cost.

In the current air emission control protocols, exhaust fines are required to be collected and processed. This is currently done by collecting the exhaust fines and either giving them away or packaging them for sale. The process disclosed herein provides a method for recycling the exhaust fines which can be reused in the process. Recycling the exhaust fines provides an improved texture and reduces cost by reutilizing a by-product of the process.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a prior art reference illustrating a flowchart for a material drying process;

FIG. 2 illustrates a prior art reference illustrating a flowchart for a material drying process for liquid raw material wherein a coagulator receives the liquid raw material;

FIG. 3 illustrates a prior art reference of a material drying process which allows for multiple input materials to be mixed into a common tank and only provides the ability to only manufacture a single final product; and

FIG. 4 illustrates a flowchart of an improved material drying process, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein are an improvement to a material drying process. The process allows for the liquid raw material to be processed without adding additional equipment and chemicals (such as a coagulator). In the current embodiments, the process yields a final product that is below 10% moisture which is considered dehydrated/dried and stable for 6-9 month shelf life. The wet raw material can then be pelletized and dried, which was not possible without using a coagulator and purchasing processing materials to mix with the liquid raw material.

In some embodiments, the process is capable of producing multiple final products based on multiple recipes using two mixers in series. This process preserves multiple wet feedstocks (high fiber, low fiber, high fat/protein) in multiple surge tanks using grinding and recirculation processes.

In some embodiments, the process includes a includes a cooler to cool the finished product once it is removed from a fluid bed dryer. It is unsafe to store the finished product directly after removing it from the fluid bed dryer as the lack of a cooling step presents a fire hazard.

In some embodiments, the system utilizes recycled exhaust gas fines. This allows for the collection of fines which are then recycled to the mixers that mix wet and dry materials which are then texturized. Recycling the fines raises the proportion of solids to achieve better extrusion properties. A collection hopper and augers are included in the process to direct the recycled fines to a mixing tank at the beginning of the material drying process.

In some embodiments, the system includes a conditioner. The conditioner provides a heat soaking chamber to hold pellets at a desired temperature for a period of time. The conditioner included in the process before cooling ensures that the products are heated to and maintained at boiling temperatures (212° Fahrenheit or 100° Celsius) for at least 30-minutes. The conditioner provides an efficient means for heating the material to temperatures and time periods required by the USDA. This addition of the conditioner reduces pathogens and provides a safer final product.

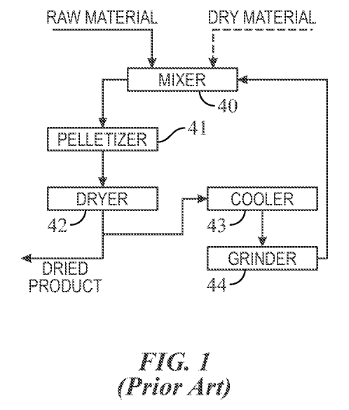

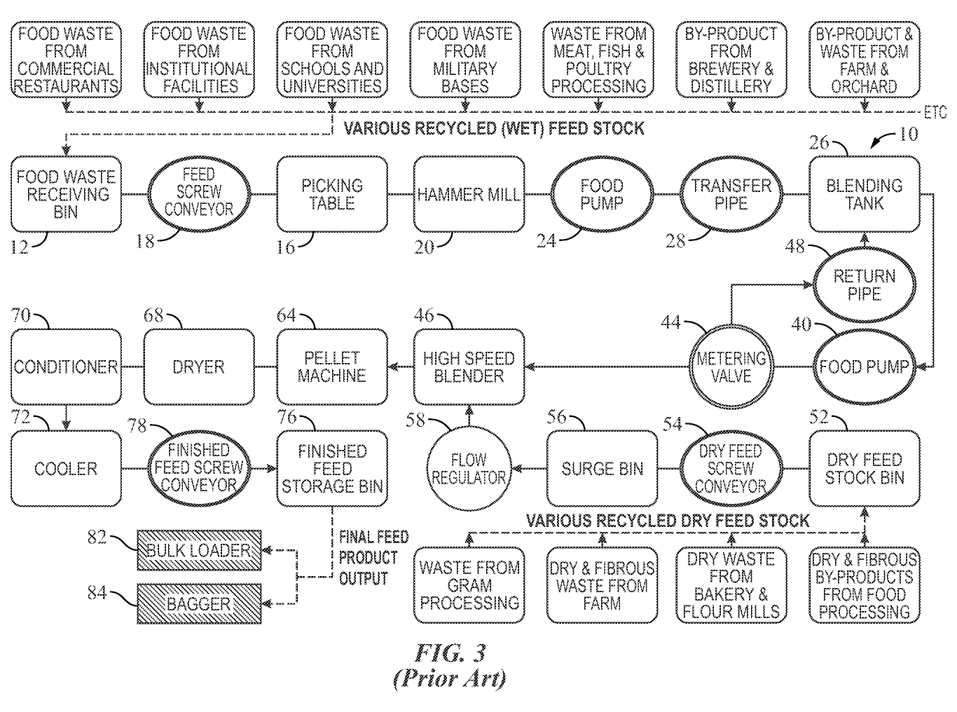

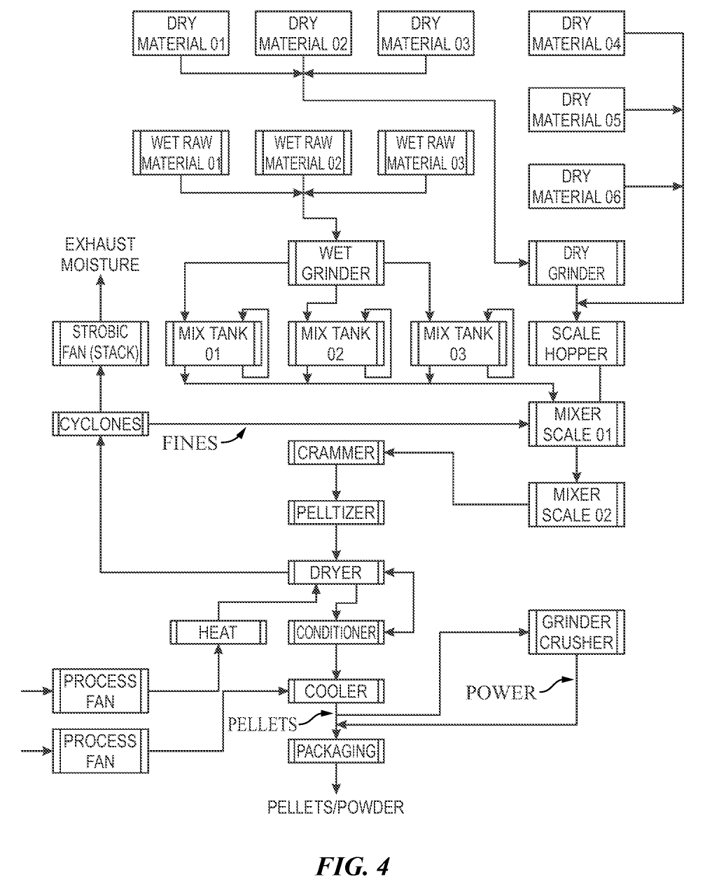

FIG. 1 illustrates a flowchart of a process disclosed in the prior art. In FIG. 1, the process allows for input materials to be processed into a single mixer, thus only allowing for a single final product to be created. FIG. 3 is a process disclosed by the prior art which allows for multiple input materials to be mixed into a common tank. The process disclosed in FIG. 3 only allows for a single final product to be manufactured, rather than multiple final products as is possible by the process disclosed in FIG. 4 and the embodiments described herein.

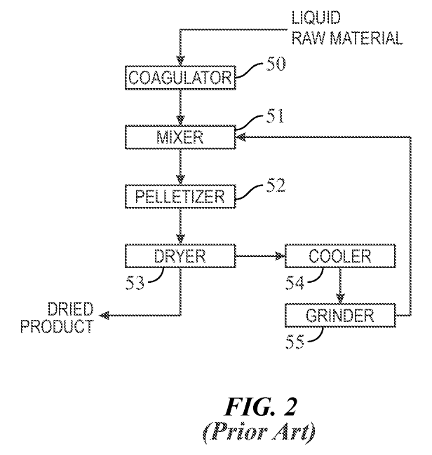

FIG. 2 illustrates a prior art reference showing the previously disclosed method. Liquid raw material was placed in a coagulator to remove the liquid/moisture so that the material could be extruded in a pelletizer. FIG. 4 illustrates a flowchart of an improved material drying process. In the improved process described herein, the wet raw material is placed in a wet grinder for a sufficient time period to grind the wet raw material. The ground wet raw material is then mixed in mix tanks before being placed in a crammer and then a pelletizer to pelletize the material. Once pelletized, the material is then transmitted to a dryer wherein heat and process fans dry the product before they are placed in a conditioner, and eventually a cooler. Following cooling, the material is transmitted to a grinder/crusher and then packaged as a pellet or powder.

The unique aspects of the material drying process illustrated in FIG. 4 are the ability to remove need to utilize a coagulator by texturizing the wet raw material using fines and recycled dried product(s).

FIG. 4 illustrates a flowchart of an improved material drying process. In the improved process described herein, the wet raw material is placed in a wet grinder for a sufficient time period to grind the wet raw material. The ground wet raw material is then mixed in mix tanks before being placed in a crammer and then a pelletizer to pelletize the material. Once pelletized, the material is then transmitted to a dryer wherein heat and process fans dry the product before they are placed in a conditioner, and eventually a cooler. Following cooling, the material is transmitted to a grinder/crusher and then packaged as a pellet or powder.

The unique aspects of the material drying process illustrated in FIG. 4 are the ability to remove the need to utilize a coagulator by texturizing the wet raw material using fines and recycled dried product(s).

The process flow schematic illustrated in FIG. 4 includes mixers to enable efficient charging of a batch in the first mixer such that an operator can vary the recipe used in each batch. The texturized material is mixed and transferred to the pelletizer with a second mixer. The process can accommodate multiple dry feed inputs and multiple wet feed inputs, with wet feed inputs recirculated to get concentration equalization (homogenization) for wet raw materials with common characteristics (for example, low fiber or high fiber). Each batch can be charged with specific relative ratios of ingredients from multiple wet and dry inputs to manufacture target specific animal feed products for low fiber, high fiber, high fat/protein, or low fat/high protein requirements. The multiple wet raw material classes can be concentration-equalized. The process allows for multiple products to be manufactured from multiple wet and dry raw materials.

During the process described in FIG. 4, exhaust fines are collected in dust collectors (e.g., high-efficiency cyclones) which are then fed to an inlet hopper and series of augers that transports the fines to the mixers at the start of the process.

The process flow schematic illustrated in FIG. 4 includes mixers to enable efficient charging of a batch in the first mixer such that an operator can vary the recipe used in each batch. The texturized material is mixed and transferred to the pelletizer with a second mixer. The process can accommodate multiple dry feed inputs and multiple wet feed inputs, with wet feed inputs recirculated to get concentration equalization (homogenization) for wet raw materials with common characteristics (for example, low fiber or high fiber). Each batch can be charged with specific relative ratios of ingredients from multiple wet and dry inputs to manufacture target specific animal feed products for low fiber, high fiber, high fat/protein, or low fat/high protein requirements. The multiple wet raw material classes can be concentration-equalized. The process allows for multiple products to be manufactured from multiple wet and dry raw materials.

During the process described in FIG. 4, exhaust fines are collected in dust collectors (e.g., high-efficiency cyclones) which are then fed to an inlet hopper and series of augers that transports the fines to the mixers at the start of the process.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A material drying process, comprising the steps of:
grinding a wet heterogeneous raw material to transform into a homogenous mixture;
mixing the wet homogeneous raw material with an amount of recycled fines and an amount of recycled dry material to texturize into a mixture that will hold its shape when extruded into a uniform size and shape;
pelletizing the mixture into uniform cylindrical spaghetti-like strands;
drying the mixture;
heating the mixture in a conditioner for a predetermined time period;
cooling the mixture in a cooler; and
processing the mixture and packaging the mixture as a final product.

2. The material drying process of claim 1, wherein the mixture is dried by passing the uniform cylindrical spaghetti-like strands through fluidizing hot air that is heated above a boiling temperature of water.

3. The material drying process of claim 1, wherein the final product is dried below 10% moisture.

4. The material drying process of claim 3, wherein the final product is stable for 6-9 months.

5. The material drying process of claim 1, wherein the material drying process utilized a sufficient amount of recycled exhaust gas fines.

6. The material drying process of claim 1, further comprising a conditioner that maintains a dried product in the presence of hot air that is held at a boiling temperature of water for a specific period of time to reduce pathogens in the final product.

7. The material drying process of claim 1, wherein the process is utilized to dry and dehydrate a single wet feedstock or a plurality of wet feedstocks.

8. The material drying process of claim 7, wherein the process is designed to manage a plurality of feedstocks comprised of a plurality of input products placed into a plurality of mixers in series.

9. The material drying process of claim 8, wherein a plurality of recycled gas fines are mixed with the plurality of input products and the recycled dry material of the same input products.

10. The material drying process of claim 9, further comprising the steps of:
collecting, via one or more high-efficiency cyclones, a plurality of exhaust gas fines;
transporting the plurality of exhaust gas fines to an inlet hopper and a series of augers;
transporting the plurality of exhaust fines to the plurality of mixers;
pelletizing the mixture into a single wet material mixed and texturized with fines and dried product of the same single ingredient, or pelletizing the mixture of two or more wet raw materials and texturized with fines and dried product of the same mixture of two or more wet raw ingredients; and
drying pelletized material derived from a single wet texturized material or two or more texturized wet raw materials.

11. A material drying process, comprising the steps of:
grinding two or more heterogeneous wet and dry raw materials to transform into a homogenous mixture;
storing the two or more wet and dry homogeneous raw materials in a plurality of mixed storage tanks;
collecting, via one or more high-efficiency cyclones, a plurality of exhaust gas fines;
transporting the plurality of exhaust gas fines to an inlet hopper and a series of augers;
transporting the plurality of exhaust gas fines to the plurality of mix tanks;
mixing the two or more wet and dry homogeneous raw materials with an amount of recycled fines and an amount of recycled dry material to texturize into a mixture that will hold its shape when extruded into a uniform size and shape;
pelletizing the mixture into uniform cylindrical spaghetti-like strands; and
drying the mixture to form a final product.

12. The material drying process of claim 11, wherein the mixture is dried by passing the uniform cylindrical spaghetti-like strands through fluidizing hot air that is heated above the boiling temperature of water.

13. The material drying process of claim 11, wherein the final product is dried below 10% moisture.

14. The material drying process of claim 11, wherein the final product is stable for 6-9 months.

15. The material drying process of claim 11, wherein the material drying process utilized a sufficient amount of recycled exhaust gas fines.

16. The material drying process of claim 11, further comprising a conditioner that maintains the dried product in the presence of hot air that is held at the boiling temperature of water for a specific period of time to reduce pathogens in the final product

17. The material drying process of claim 11, wherein the process is utilized to dry and dehydrate a plurality of wet and dry feedstocks.

18. The material drying process of claim 17, wherein the process is designed to manage a plurality of feedstocks comprised of a plurality of input products placed into a plurality of mixers in series.

19. The material drying process of claim 18, wherein a plurality of recycled gas fines are mixed with the plurality of input products and the recycled dry material of the same input products.

20. A system for a material drying process, the system comprising:
a grinder to grind two or more heterogeneous wet and dry raw materials to transform each material into homogeneous mixtures of each material
a plurality of storage tanks to store each homogeneous mixture of two or more wet and dry materials;
one or more high-efficiency cyclones to collect a plurality of exhaust gas fines;
an inlet hopper including a series of augers to receive the plurality of exhaust gas fines, wherein the plurality of exhaust gas fines are transported to the plurality of mix tanks;
a series of mix tanks in series to mix the two or more homogeneous wet and dry raw materials with an amount of recycled dry fines and an amount of recycled dry material of the same input products to texturize into a mixture that will hold its shape when extruded into a uniform size and shape.
a pelletizer to pelletize the mixture into uniform cylindrical spaghetti-like strands;
a dryer to dry the uniform cylindrical spaghetti-like strands to form a final product, wherein the final product is a feedstock.
